(19) United States
(12) Patent Application Publication
(10) Pub. No.: US 2003/0083081 A1
(43) Pub. Date: May 1, 2003

(54) Service management agent for managing the provision of different services to a communication device

(76) Inventors: Stephen Harold Sanders III, Glenview, IL (US); Paul M. Bocci, Roselle, IL (US); Gregory A. Dertz, Algonquin, IL (US)

Correspondence Address: MOTOROLA, INC., 1303 EAST ALGONQUIN ROAD, IL01/3RD, SCHAUMBURG, IL, 60196

(21) Appl. No.: 10/052,800

(22) Filed: Oct. 29, 2001

(51) Int. Cl. H04Q 7/20

(52) U.S. Cl. 455/466; 455/521; 455/414

(57) ABSTRACT

A wireless communication system (100) contains a number of service providers (145, 148, 149) that provide different services to communication units (105-108). The communication units (105-108) are limited as to how many of the services they can concurrently receive. Each communication unit (105-108) is associated with a service manage agent (SMA) (185-190) that manages the provision of the services to the communication unit (105-108). In one embodiment, each SMA (185-190) manages the provision of the services to only one of the communication units (105-108).

### FIELD OF THE INVENTION

This invention relates generally to communication systems and more particularly to a communication system that provides multiple services to communication devices.

### BACKGROUND OF THE INVENTION

Older wireless communication systems just provided a single service. For example, cellular phone systems provided telephone service to wireless communication devices that was equivalent to traditional landline telephone service. Paging systems provided short message service to wireless communication devices. Private radio systems such as those used by public safety agencies provided dispatch service in which multiple wireless communication devices could communicate with each other and with dispatch consoles.

Newer wireless communication systems can provide a variety of services. For example, a cellular phone system may also offer a short message paging service or dispatch service. A private radio system may offer telephone interconnect service that is indistinguishable from cellular telephone service. In addition to the traditional services of dispatch, cellular phone service and paging, other services are also being offered by wireless communication systems. For example, packet data services that deliver packets of data to wireless devices in a fashion similar to the delivery of data packets on a computer network are being added to wireless communication systems. Examples of additional services that could be included in wireless communication systems are electronic mail, location services and electronic commerce.

When multiple services are provided in a wireless communication system, different devices in the system, called service providers, typically provide the different services. For example, the telephone interconnect service is typical provided by a telephone switch. The dispatch service may be provided by the telephone switch or by a separate dispatch switch. The packet data service may be provided by a packet data gateway.

The provision of the different services to a wireless communication device in the wireless communication system can lead to conflicts among the different service providers. For example, a telephone switch may attempt to place a phone call to the wireless communication device while it is receiving data packets from a packet data gateway. There are two ways that conflicts between service providers are handled by wireless communication systems. One method is to have the wireless communication device ignore the second service provider. In this case the wireless communication device will appear to be turned off to the second service provider. This is undesirable because it provides false information about the status of the wireless communication device.

The second method is to have a global service manager control the provision of all services to all the wireless communication devices in the wireless communication system. When a service provider desires to provide a service to a wireless communication device, it first contacts the global service manager. The global service manger tracks the provision of services to each wireless communication device and resolves any conflicts. Because a typical wireless communication system can have hundreds, if not thousands of wireless communication devices, the global service manager is usually a complex and expensive device.

It would be desirable to have a new solution for managing the provision of multiple services to wireless communication devices. Ideally, this solution will be less expensive and complex than the global service managers that have been employed in some wireless systems. This invention is directed to satisfying this need.

### BRIEF DESCRIPTION OF THE DRAWINGS

The foregoing and other advantages of the invention will become apparent upon reading the following detailed description and upon reference to the drawings in which:

FIG. 1 is a diagram of a wireless communication system according to one embodiment of the present invention;

FIG. 2 is a flowchart illustrating a method for providing services to a communication device in a communication system;

FIG. 3 is a flowchart showing a method for a service management agent (SMA) to make a determination of whether a first service can be provided to a communication device;

FIG. 4 is a flowchart showing another method for a SMA to make a determination of whether the first service can be provided to a communication device;

FIG. 5 is a flowchart illustrating a method for providing services to a communication device in a communication system;

FIG. 6 is a flowchart illustrating a method for an SMA to manage the provision of services to a communication device;

FIG. 7 is a flowchart illustrating another method for an SMA to manage the provision of services to a communication device;

FIG. 8 is a flowchart illustrating still another method for an SMA to manage the provision of services to a communication device.

### DESCRIPTION OF A PREFERRED EMBODIMENT

The present invention is directed to an apparatus and method for managing the provision of multiple services to wireless communication devices in a wireless communication system. A service management agent manages the provision of the multiple services to one or more wireless devices. The service management agent may be located anywhere in the wireless communication system. A provider of services desiring to provide services to a wireless communication device first contacts the service management agent associated with that device. The service management agent then determines whether the service can be provided to the wireless device.

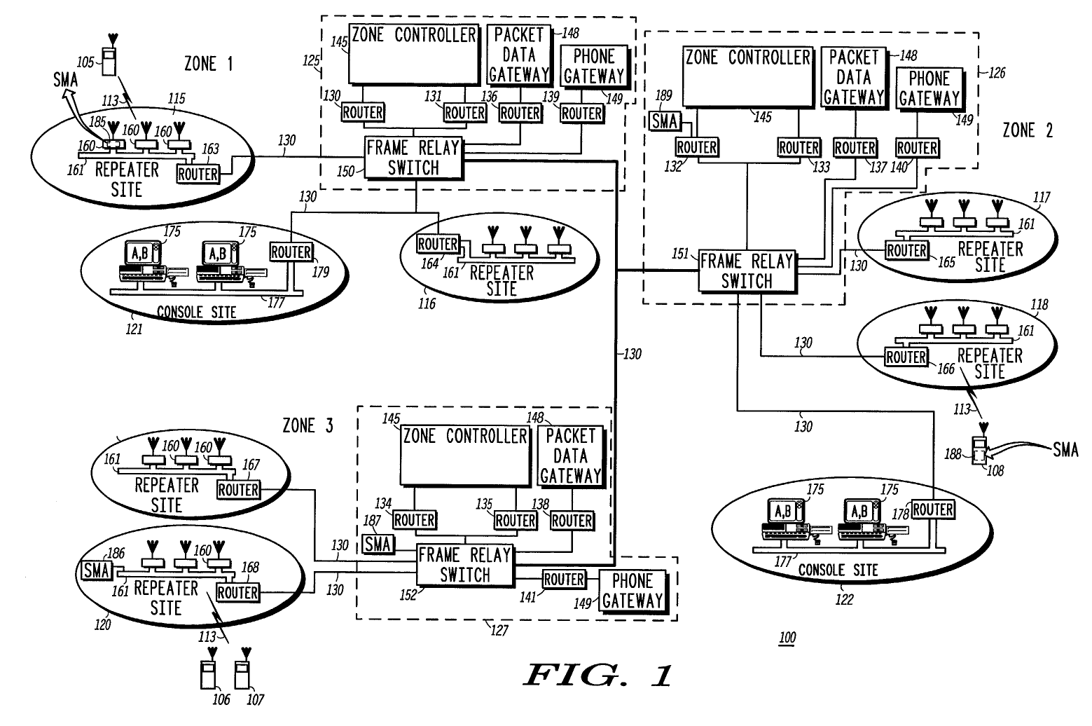

Turning now to the drawings and referring initially to FIG. 1, there is shown a wireless communication system 100 that employs the present invention. The wireless communication system 100 supports the provision of multiple services to wireless communication devices 105-108 over communication resources 113. Such services can include, for example, telephone service, dispatch service, electronic mail, paging service, electronic commerce, location service and packet data service. The wireless communication system 100 comprises a plurality of repeater sites 115-120, console sites 121, 122 and core sites 125-127 interconnected by site links 130. The wireless communication system is divided into three zones labeled as “zone 1”, “zone 2” and “zone 3” on FIG. 1. Each of the zones contains one of the core sites 125-127, one or more of the repeater sites 115-120 and possibly a console site 120-121.

In one embodiment, the communication devices 105-108 comprise wireless radio terminals that are equipped for 2-way communication of voice and data. The communication devices 105-108 may be capable of transmitting and receiving voice communication such as required for telephone communication or dispatch service. The communication devices 105-108 may also be equipped for sending and receiving of IP datagrams (or packets) associated with multimedia calls (e.g., voice, data or video, including but not limited to high-speed streaming voice and video) and data transfers singly or simultaneously with other devices in the wireless communication system 100. As will be appreciated, in general the communication devices 105-108 may comprise virtually any mobile or portable wireless radio devices, cellular radio/telephones, devices having varying capacities to accommodate multimedia calls, video terminals, portable computers with wireless modems, or any other wireless devices.

The repeater sites 115-120 include a plurality of base stations 160 that are coupled via a local area network (LAN) 161 such as, for example, Ethernet, Token Ring, or any other commercial or proprietary LAN technology, to a router 163-168. As will be appreciated, the base stations 160 at the various repeater sites 115-120 communicate, via wireless communication resources 113 with the communication devices 105-108. As will be appreciated, the wireless communication resources 113 may comprise any of the currently available resources, such as, for example, radio frequency (RF) technologies, including, but not limited to Code Division Multiple Access (CDMA), Time Division Multiple Access (TDMA), Frequency Division Multiple Access (FDMA), and the like. Moreover, the invention of the present application may be used in any of the currently available Radio Frequency (RF) communication systems, such as, for example, Global System for Mobile communication (GSM), General Packet Radio Service (GPRS), Universal Mobile Telecommunications Service (UMTS), Trans-European Trunked Radio service (TETRA), Association of Public Safety Communication Officers (APCO) Project 25, Personal Communication Service (PCS), Advanced Mobile Phone Service (AMPS) and the like. In the alternative, other wireless technologies, such as those now known or later to be developed and including, but not limited to, infrared, third generation (3G) cellular systems, Bluetooth, electric field, electromagnetic, or electrostatic transmissions, will offer suitable substitutes.

Console sites 121, 122 include a plurality of dispatch consoles 175 that are coupled via LAN 177 to a router 178, 179. Although not shown in FIG. 1, it will be appreciated that a single site may include a combined repeater/console site. The dispatch consoles are used to communicate with the communication devices 105-108 from a fixed location.

The core sites 125-127 comprise a number of routers 130-139, a zone controller 145, a packet data gateway 148, a phone gateway 149 and a frame relay switch 150. The routers 130-138 may be any commercially available router. At each of the core sites 125-127, two of the routers 130-135 are coupled to a zone controller 145 and a frame relay switch 150. Another router 135-138 is coupled to the frame relay switch 150 and the packet data gateway 148. Still another router 139-141 is coupled between the phone gateway 149 and the frame relay switch 150. The frame relay switches 150 use the frame relay protocol to transport data between the routers 130-141 at the core sites 125-127, the repeater and console sites 115-121, and the other core sites 125-127. As is well known, frame relay can be used to transport Internet Protocol (IP) packets using private virtual circuits (PVC) between routers. For example, the link between the frame relay switch 150 and a router 163 at repeater site 115 may contain PVC from all the routers 130, 131, 136, 139 in the Zone 1 core site 125. To the routers 130, 131 the shared link between the frame relay switch 150 and router 163 appear to be two separate physical links. It will be appreciated that the console sites 121, 122 may be co-located with the core sites 125-127 or the repeater sites 115-120 and that the core site equipment (i.e. routers, zone controllers, packet data gateway and frame relay switches) for multiple zones may be co-located at a single site.

The zone controllers 145 manage the provision of dispatch and telephone service to the communication devices 105-108 within their respective zones. Data associated with dispatch and telephone services is routed through the communication system 100 using the well-known multicast routing feature of the Internet Protocol (IP). For telephone service, the zone controller 145 assigns an IP multicast address for each telephone call. The multicast address is then used by the routers 130-141, 163-168, 178, 179 in the communication system to route packets of data containing the telephone conversation between the phone gateways 149 and the communication devices 105-108. With dispatch service, communication is established between multiple communication devices 105-108 and/or consoles 175. The group of communication devices 105-108 and consoles 175 participating in a dispatch call is called a talk group. The zone controller 145 assigns an IP multicast address for the talk group. This multicast address is used to route packets of data containing the talk group conversation to all the members of the talks group. For any given telephone or dispatch call, only one of the zone controllers 145 will assign the IP multicast address. This zone controller 145 is known as the controlling zone controller for the call. The controlling zone controller 145 for the call can be determined in a number of different ways. Some methods for choosing the controlling zone controller and the assignment of IP multicast address are described in U.S. patent application Ser. No. 09/871,409, titled “Method For Improving Packet Delivery In An Unreliable Environment” which is hereby incorporated by reference in its entirety.

The zone controllers 145 also handle a number of other tasks. The zone controllers 145 track the locations of the communication devices 105-108 as they move about the wireless communication system 100. When the communication devices 105-108 move from one location in the communication system 100 to another, the zone controllers 145 make sure that the data packets destined for the communication devices 105-108 are routed to the correct location. The zone controllers also assign the communication resources 113 for use by the communication devices 105-108. The zone controllers 145 keep track of when the communication devices 105-108 are connected to the communication system 100 (i.e. they track which communication devices 105-108 are turned on).

The packet data gateways 148 send and receive packets of data to and from the communication devices 105-108. The packet data gateways 148 are connected to data communication networks such as the Internet (not shown) or other communication networks (not shown) such as private intranets. The packets of data originate in the data communication networks, from the communication devices 105-108 or from other devices within the wireless communication system 100. The packet data gateways 148 receive information about the locations of the communication devices 105-108 in the communication system 100 from the zone controllers 145. The packet data gateways 148 use the location information to route the data packets to the proper place within the wireless communication system 100.

The phone gateways 149 connect the wireless communication system 100 to the public switched telephone network (PSTN) (not shown). The phone gateway allows telephone conversations to take place between the communication devices 105-108 and telephones connected to the PSTN. For voice traveling from the PSTN to the communication devices 105-108, the phone gateway converts the voice signal to a digital waveform, divides the digital waveform into packets and then sends the packets to the communication device 105-108 using the IP multicast address assigned by the zone controller 145. For the voice traveling from the communication devices 105-108 to the PSTN, the phone gateway 149 converts the packets of data received from the communication devices 105-108 to a voice waveform that can be sent to the PSTN.

The site links 130 connect the console sites 121-122, repeater sites 115-120 and core sites 125-127. The site links 130 maybe fiber optic cables, T1 lines, E1 lines, coaxial cable, fixed point-to-point radio links or other suitable means for providing a data link between the various sites of the radio communication system 100.

The wireless communication system 100 also contains a plurality of service management agents (SMAs) 185-190. SMAs 185-190 manage the provision of multiple services in the wireless communication system 100 to the different communication devices 105-108. The SMAs 185-190 maybe stand alone devices within the wireless communication system 100; hardware integrated into one of the devices of the wireless communication system 100 such as the basestations 160, zone controllers 145, gateways 148, 149, etc; or software programs running within a microprocessor in any device of the wireless communication system 100. As such, SMAs 185-190 can be located in a number of different places within the wireless communication system 100 as illustrated in FIG. 1. For example, the SMAs 185-190 maybe attached to the LANS 161, 177 at the repeater 115-120 or console 121, 122 sites or at the core sites 125-127 attached to the frame relay switch 150-152 or routers 130-141. The SMAs 185-190 may also be co-located with one of the base stations 160, communication devices 105-108, zone controllers 145, phone gateways 149 or packet data gateways 148. The SMAs 185-190 manage the provision of services to the plurality of communication devices 105-108. In one embodiment of the present invention, each SMA 185-190 manages the provision of services to only one of the communication devices 105-108 while in another embodiment each SMA 185-190 may manage the provision of services to multiple communication devices 105-108.

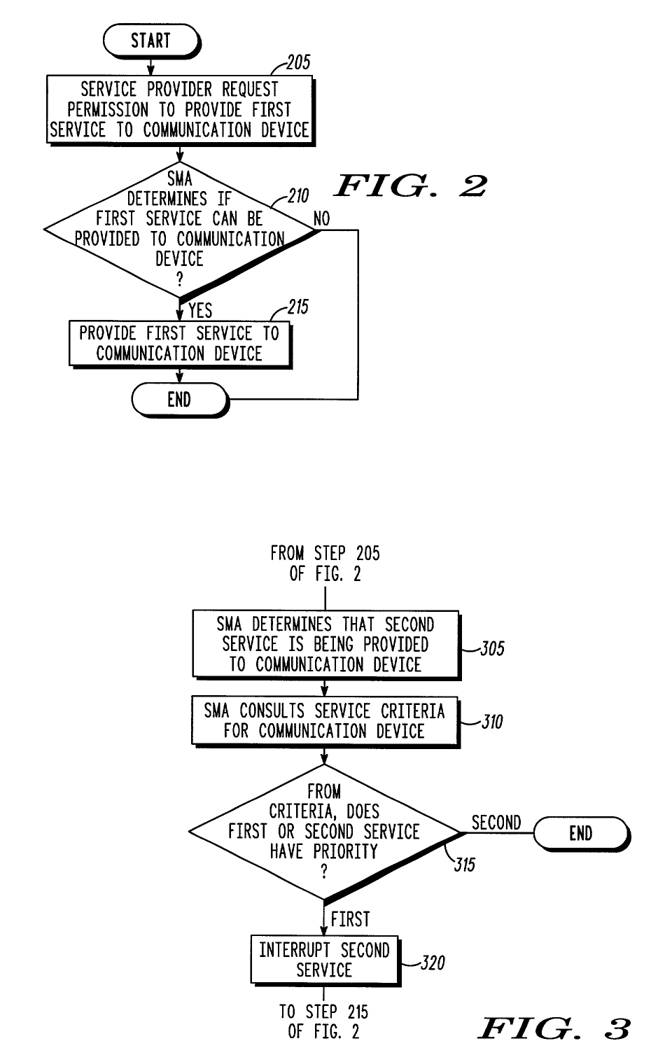

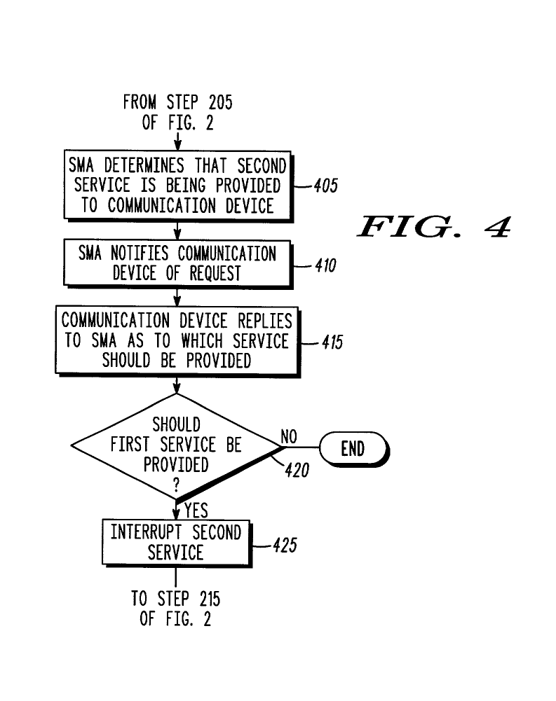

Each of the communication devices 105-108 in the wireless communication system 100 is associated with a SMA 185-190. The SMAs 185-190 mediate between the multiple service providers that provide services to the communication devices 105-108. Such service providers can include, for example, the zone controllers 145, packet data gateways 148, phone gateways 149, electronic mail gateways (not shown), paging gateways (not shown) game servers (not shown) or electronic commerce gateways (not shown). Depending on the capabilities of the wireless communication devices 105-108 and the wireless communication resources 113, either one or multiple services may be provided to the communication devices 105-108. Any service provider that desires to provide a service to a communication device 105-108 contacts the SMA 185-190 associated with the communication device 105-108. The SMA 185-190 then determines if the service can be provided to the communication device 105-108. The methods that the SMA uses to determine if the service can be provided to the communication device 105-108 are described below with regard to FIGS. 2-8.

Practitioners skilled in the art will appreciate that the communication system 100 may include various other entities not specifically shown in FIG. 1. For example, the communication system 100 may contain a link such as, for example a T1 line or E1 digital carrier system that connects the routers 130-140 to a paging network or short message system via a paging gateway, and a facsimile machine or similar device via a fax gateway or modem. In support thereof, the communication system 100 may include any number or type of wire line communication device(s), site controller(s), comparator(s), telephone interconnect device(s), internet protocol telephony device(s), call logger(s), scanner(s) and gateways, collectively referred to herein as a fixed communication device(s) or simply fixed devices. Generally, such fixed communication devices may be either sources or recipients of payload and/or control messages routed through the communication system 100.

As will be further appreciated by those skilled in the art, many variations of the communication system 100 of FIG. 1 are possible. Any number of zones may be present in the communication system 100. Each zone may contain a different number of repeater sites or console sites. The functions of the zone controller may be split among several devices or zone controllers for multiple zones may be combined in a single device. More or less than four routers may be present at each core site. The configuration of routers and other devices at the core, repeater and console sites may be different. Additional types of gateways may be present at the core sites 125-127. These gateways may include for example, fax gateways, paging gateways, electronic mail gateways or electronic commerce gateways. The gateways may be present in the wireless communication system 100 at places other than core sites 125-127. The zone controllers, packet gateways and routers may be connected using LAN technology such as, for example, Ethernet, Token Ring, or other commercially available LAN technology rather than using a direct connection. Multiple LANs may be used for connection between the zone controller, packet gateways and routers or multiple zone controllers may be present in a zone to increase the system reliability. The frame relay switch may be replaced by some other technology such as for example, Asynchronous Transfer Mode (ATM), FDDI, or IP routers. The wireless communication system 100 may include one or more simulcast sites. Simulcast sites simultaneously broadcast identical signals to communication devices from several different base stations. This can improve the reliability of communication to the communication devices 105-108. As will be appreciated many other variations of the communication system 100 are possible without departing from the spirit and scope of the present invention.

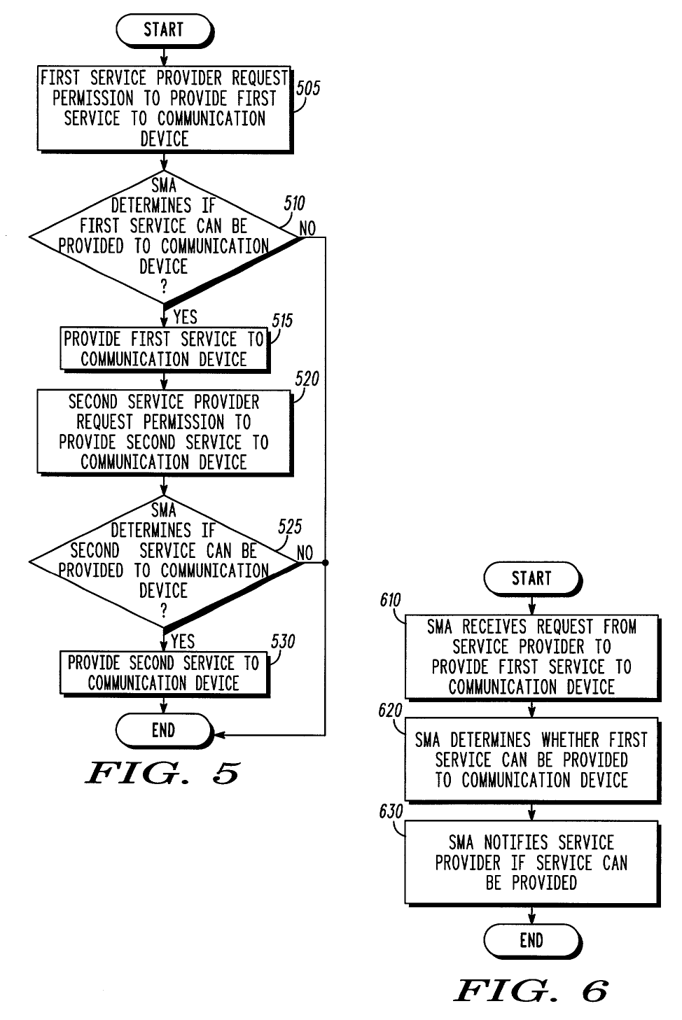

FIGS. 2-8 outline processes related to the provision of services to communication devices in a wireless communication system. In each of these processes, each of the communication devices is associated with one SMA. In one embodiment of the present invention, each SMA manages the provision of services to one communication device. In another embodiment of the present invention, each SMA manages the provision of services to a plurality of communication devices. FIG. 2 and FIG. 5 illustrate methods for providing services to a communication device in a communication system. FIGS. 6-8 illustrate methods for an SMA to mange the provision of services to a communication device.

FIG. 2 is a flowchart illustrating a method for providing services to a communication device in a communication system. At step 205, a service provider request permission from an SMA associated with a communication device to provide a first service to the communication device. The service provider may be, for example, a packet data gateway, zone controller, paging gateway, electronic mail gateway, electronic mail gateway, game server or phone gateway. Next, at step 210, the SMA determines if the first service can be provided to the communication device. The SMA can make this determination in a number of ways. Some examples of methods that the SMA may use to make this determination are:

The SMA may determine that the first service can be provided to the communication device if no other services are being provided to the communication device.

The SMA may determine that the first service can be provided to the communication device if the first service has a higher priority than other services being provided to the communication device. The priority of the services is determined by service criteria for the communication device. The service criteria may be determined from several sources such as, for example, input from the user of the communication device or by the management of the wireless communication system. The service criteria prioritize the services using a number of different factors. The criteria may make decisions as to which services have priority based on, for example, the time of day, date, identity of the caller or type of service. For example, telephone calls may have priority over packet data service, dispatch calls from a supervisor may have priority over other services, or telephone calls from work colleagues may have priority over other calls only during working hours.

The SMA may determine that the first service can be provided to the communication device by adding the bandwidth required for the first service to the bandwidth required for any other services being provided to the communication unit. If the total bandwidth is less than a characteristic bandwidth of the communication device, the SMA makes a determination that the first service can be provided. The characteristic bandwidth may be determined, for example, by the available communication resources or the type of communication device.

Any of the previous methods may be combined. For example, if the total bandwidth of all the services is less than the characteristic bandwidth, the first service could be provided if it is higher priority than one of the other services.

FIG. 3 and FIG. 4 are flowcharts showing two possible processes by which the SMA can make the determination in step 210. As will be appreciated by those skilled in the art, many other processes for the SMA to make the determination are possible. If the SMA determines that the first service can be provided to the communication device, at step 215 the first service provider provides the service to the communication device. If at step 210 the SMA determines that the first service can not be provided to the communication device, the process ends.

FIG. 3 is a flowchart showing a method for the SMA to make a determination of whether a first service can be provided to the communication device in step 210 of FIG. 2. After step 210 of FIG. 2, at step 305, the SMA determines that a second service is being provided to the communication device. Then, at step 310 the SMA consults a service criteria for the communication device. The service criteria is a list of rules for determining what services should be provided to the communication device and how conflicts between multiple services should be resolved. The service criteria may take many different forms. For example, the service criteria may be a list of priorities for the different services. The priorities may depend on different factors such as the time of day, day of the week or length of time since a particular service has been provided to a communication device. The priorities may depend on characteristics of the various services. For example, dispatch calls from a console may have priority over telephone calls or a telephone call from a supervisor may have priority over other services. The service criteria may be dependant on the input from the user of the communication device or may be specified by the management of the wireless communication system. Depending on the service criteria, at step 315 the SMA decides whether the second service or the first service has priority. If the first service has priority over the second service, at step 320, the second service is interrupted. The first service is then provided to the communication device at step 215. At step 315, if the second service has priority over the first service the process ends.

FIG. 4 is a flowchart showing another method for the SMA to make a determination of whether the first service can be provided in step 210 of FIG. 2. After step 205 of FIG. 2, at step 405 the SMA determines that a second service is being provided to the communication device. Then, at step 410 the SMA notifies the communication device of the request by the service provider to provide the first service. At step 415 the communication device replies to the SMA as to whether the first service should be provided to the communication device or whether the second service should continue to be provided to the communication device. The communication device can make this reply responsive to inputs from a user of the communication device or a set of criteria programmed into the communication device. The criteria may take a number of different forms. For example, the user may specify that certain types of services have priority over other types of services (such as telephone service having priority over dispatch or packet data). The criteria may depend on various factors such as time of data, location of the user, date, the party originating a telephone, dispatch or packet data message etc. At step 420, the SMA determines whether the first service should be provided to the communication device responsive to the reply. If the first service should be provided, at step 425 the second service is interrupted. The first service is then provided to the communication device at step 215 of FIG. 2.

FIG. 5 is a flowchart illustrating another method for providing services to a communication device in a communication system. At step 505, a first service provider request permission from an SMA associated with a communication device to provide a first service to the communication device. The first service provider may be, for example, a packet data gateway, zone controller, paging gateway, electronic mail gateway, electronic mail gateway, game server or phone gateway. Next, at step 510, the SMA determines if the first service can be provided to the communication device. The SMA may consider a number of different factors in making this determination. For example, the SMA could allow the first service to be provided to the communication device if there is currently no other service being provided to the communication device. If another service is being provided to the communication device, the SMA may have a set of criteria for determining which service should have priority. It may also be possible for the SMA to allow multiple services to be provided to the communication device at the same time. Examples of methods that the SMA may use to determine whether the first service can be provided to the communication device are described above with regard to step 210 of FIG. 2. The determination in step 510 can also be made by the methods in the flowcharts of FIG. 3 or FIG. 4. If the SMA determines that the first service can be provided to the communication device, at step 515 the first service provider provides the first service to the communication device. If at step 510 the SMA determines that the first service can not be provided to the communication device, the process ends.

At step 520 a second service provider request permission from the SMA associated with the communication device to provide a second service to the communication device. At step 525, the SMA determines whether the second service can be provided to the communication device. This determination can be made using the same or a different method than the determination of step 510. At step 525, if the second service can not be provided to the communication device, the process ends. However, if the second service can be provided to the communication device at step 525, the second service is provided to the communication unit at step 530. While the process of FIG. 5 is described with regard to provision of first and second services, it will be appreciated by those skilled in the art that this process can easily be extended to any number of services and service providers.

FIG. 6 is a flowchart illustrating a method for an SMA to mange the provision of services to a communication device. At step 610, the SMA receives a request from a service provider to provide a first service a communication device. The first service may be, for example, a packet data gateway, zone controller, paging gateway, electronic mail gateway, electronic mail gateway, game server or phone gateway. At step 620, the SMA determines whether the first service can be provided to the communication device. The SMA can make this determination in a number of ways. Some examples of methods that the SMA can use to make this determination were described above with respect to step 210 of FIG. 2 and in FIG. 3 and FIG. 4. After the determination has been made, at step 630, the SMA then notifies the service provider whether the service can be provided to the communication device.

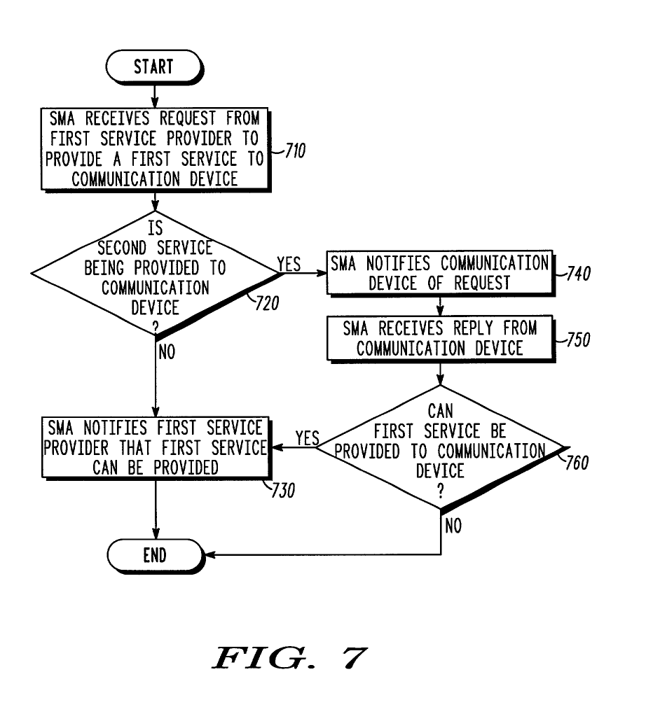

FIG. 7 is a flowchart illustrating another method for an SMA to mange the provision of services to an associated communication device. At step 710, the SMA receives a request from a first service provider to provide a first service to the communication device. At step 720, the SMA determines whether a second service is already being provided to the communication device. If no second service is being provided to the communication device, at step 730 the SMA notifies the first service provider that the first service can be provided to the communication device. At step 720 if there is a second service being provided to the communication device, at step 740 the SMA notifies the communication device of the request by the first service provider to provide the first service. At step 750, the SMA then receives a reply from the communication device. At step 760, responsive to the reply from the communication device, the SMA determines if the first service can be provided to the communication device. If the first service can be provided to the communication device, at step 730 the SMA notifies the first service provider that the first service can be provided to the communication device. If at step 760, the SMA determines that the first service can not be provided to the communication device, the process ends.

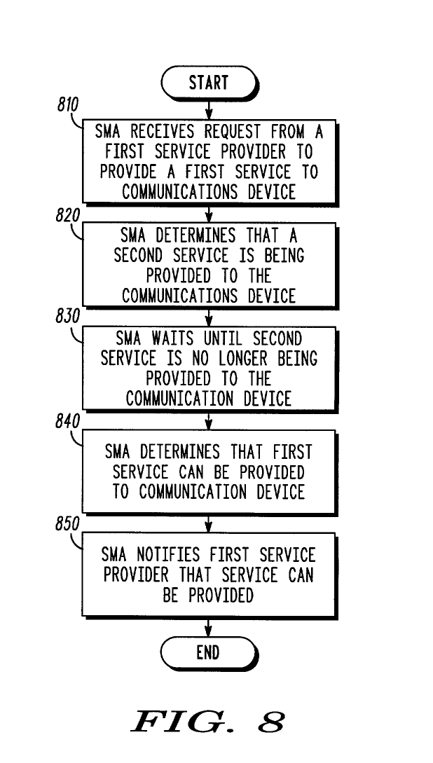

FIG. 8 is a flowchart illustrating still another method for an SMA to mange the provision of services to an associated communication device. At step 810, the SMA receives a request from a first service provider to provide a first service to a communication device. At step 820 the SMA determines that a second service is being provided to the communication device. Then, at step 830 the SMA waits until the second service is no longer being provided to the communication device. After the second service is no longer being provided to the communication device, at 840 the SMA determines that the first service can be provided to the communication device. The SMA then notifies the first service provider that the first service can be provided to the communication unit at step 850.

While the methods of FIGS. 2-8 have been described with respect to providing services to communication devices in a wireless communication system, it will be appreciated that this invention is applicable to other types of systems. For example, the present invention may be used in a computer network in which services are provided by a plurality of servers to computers. The services may be, for example, software programs, world wide web pages, video games etc. SMAs can be used in accordance with the present invention to manage the provision of the services to the computers so that the computers or the data links to the computers do not become overloaded. As will be appreciated by those skilled in the art, the present invention may be employed in any circumstance were multiple service providers or servers are providing services to a single device with limited resources.

The present invention provides a means to manage the provision of services to a communication device in a wireless communication network. Through the use of SMAs, conflicts between multiple service providers that are attempting to provide services to the communication device are resolved. The present invention accomplishes the resolution of these conflicts without the use of an expensive and complex global service manager.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A wireless communication system comprising:
a plurality of communication devices;
a plurality of base stations adapted to provide radio communication resources for use by the plurality of communication devices;
a packet network for connecting the plurality of base stations;
a service management agent adapted to manage the provision of different types of services to an individual communication device of the plurality of communication devices.

2. The wireless communication system of claim 1 wherein the service management agent is co-located with the individual communication device.

3. The wireless communication system of claim 1 wherein the service management agent is co-located with a device of the packet network.

4. The wireless communication system of claim 3 wherein the device of the packet network contains a microprocessor and the service management agent is software executing on the microprocessor.

5. The wireless communication system of claim 1 wherein the service management agent is co-located with one of the plurality of base stations.

6. The wireless communication system of claim 1 wherein the service management agent is a first service management agent and the individual communication device is a first communication device, the wireless communication system further comprising:
a second service management agent adapted to manage the provision of different types of services to a second communication device of the plurality of communication devices.

7. The wireless communication system of claim 6 wherein the first service management agent and the second service management agent are in different locations.

8. The wireless communication network of claim 6 wherein the first service management agent and the second service management agent are co-located.

9. A method for providing services to a communication device comprising:
requesting by a service provider, from a service management agent associated with a communication device, permission to provide a service to the communication device;
determining, by the service management agent whether the service can be provided to the communication device; and
if the service can be provided to the communication device, providing the service to the communication device by the service provider.

10. The method of claim 9 wherein the step of determining comprises:
making a positive determination if no other service provider is currently providing another service to the communication device; and
making a negative determination if another service provider is currently providing another service to the communication device.

11. The method of claim 9 wherein the service is a first service and the step of determining comprises the steps of:
determining that a second service is being provided to the communication device;
consulting, by the service management agent, a service criteria for the communication device;
determining, from the service criteria whether the first or second service has priority; and
if the first service has priority, interrupting the second service.

12. The method of claim 9 wherein the service is a first service and the step of determining comprises the steps of:
determining that a second service is being provided to the communication device;
notifying, the communication device by the service management agent, that the request to provide the first service to the communication device has been made;
replying, by the communication device to the service management agent, as to whether the first service should be provided to the communication device; and
if the first service should be provided to the first communication device, interrupting the second service.

13. The method of claim 9 wherein the service is a first service and the service provider is a first service provider, the method further comprising the steps of:
requesting by a second service provider, from the service management agent, permission to provide a second service to the communication device;
determining, by the service management agent whether the second service can be provided to the communication device; and
if the second service can be provided to the communication device, providing, by the second service provider the second service to the communication device.

14. A method for a service management agent to facilitate the provision of services to a communication device comprising the steps of:
receiving, by the service management agent, a request by a service provider to provide a first service to the communication device;
determining, by the service management agent, whether the first service can be provided to the communication device; and
notifying, the service provider whether the first service can be provided to the communication device.

15. The method of claim 14 wherein the step of determining comprises the steps of:
determining whether a second service is being provided to the communication device; and
if a second service is not being provided to the communication device, determining that the first service can be provided to the communication device.

16. The method of claim 14 wherein the communication device has a characteristic bandwidth and the step of determining comprises the step of:
adding the bandwidth required for the first service to the bandwidth required for any other services being provided to the communication device to obtain a total bandwidth; and
if the total bandwidth is less than the characteristic bandwidth of the communication device, making the determination that the first service can be provided to the communication device.

17. The method of claim 14 wherein the service provider is a first service provider and wherein the step of determining comprises the steps of:
determining, by the service management agent that a second service is being provided to the communication device by a second service provider;
notifying the communication device, by the service management agent, that the first service provider request to provide the first service to the communication device;
responsive to a reply from the communication device, determining that the first service can be provided to the communication device.

18. The method of claim 17 further including the step of:
notifying the second service provider, by the service management agent, that the second service provider should stop providing the second service to the communication device.

19. The method of claim 14 wherein the first service is selected from the group consisting of telephone calls, dispatch calls, pages and electronic mail.

20. The method of claim 14 wherein the service provider is a first service provider and wherein the step of determining comprises the steps of:
determining, by the service management agent that a second service is being provided to the communication device by a second service provider; and
waiting, until the second service is no longer being provided to the communication device by the second service provider.
determining, by the service management agent that the first service can be provided to the communication device.
